(19) United States
(12) Patent Application Publication
(10) Pub. No.: US 2010/0053603 A1
(43) Pub. Date: Mar. 4, 2010

(54) Surface inspection apparatus and surface inspection method

(75) Inventors: Naoshi Sakaguchi, Kawasaki-shi (JP); Takashi Watanabe, Naka-gun (JP); Daisaku Mochida, Nagoya-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/588,877

(22) Filed: Oct. 30, 2009

Related U.S. Application Data
(63) Continuation of application No. PCT/JP2008/001194, filed on May 13, 2008.

(30) Foreign Application Priority Data
May 14, 2007 (JP) 2007-128238

(51) Int. Cl. G01N 21/88

(52) U.S. Cl. 356/237.4

(57) ABSTRACT

A surface inspection apparatus includes an illuminating part illuminating an edge part of a substrate from a direction deviated from a direction of normal line of the edge part by an angle being predetermined, the edge part being inclined and the substrate being an inspection target, an imaging optics forming an image from a diffracted light from a captured area of the edge part as a dark field image, an imaging part capturing the dark field image obtained by the imaging optics, and a detecting part detecting a defect based on whether or not a striated image appears on the dark field image corresponding to the edge part obtained by the imaging part.

### CROSS REFERENCE TO THE RELATED APPLICATIONS

This application is a continuation application of International Application PCT/JP2008/001194, filed May 13, 2008, designating the U.S., and claims the benefit of priority from Japanese Patent Application No. 2007-128238, filed on May 14, 2007, the entire contents of which are incorporated herein by reference.

### BACKGROUND

1. Field

The present application relates to a surface inspection apparatus and a surface inspection method for an edge part of a semiconductor wafer used in manufacturing an integrated circuit.

2. Description of the Related Art

There have been proposed various surface inspection techniques for an area on a semiconductor wafer (hereinafter, simply referred to as a wafer) on which an integrated circuit is formed. For instance, a macro-inspection apparatus that surveys a whole surface, a micro-inspection apparatus capable of performing a detailed inspection of a part of an area of a wafer, and the like have been applied. These pieces of automatic inspection apparatus are configured on the assumption that they inspect defects on mirror-finished flat surfaces.

On the other hand, an edge part of the wafer is a circular ring-shaped part that corresponds to an outer edge of a disk-shaped wafer. One of the characteristics of the edge of the wafer is that it includes an inclined part that inclines with respect to a flat surface of the wafer (hereinafter, referred to as a beveled part), and an end face part substantially perpendicular to the surface of the wafer (hereinafter, referred to as an apex part). Further, an inclination angle of the aforementioned beveled part increases as the beveled part goes toward a peripheral part, and then the beveled part is continued to the apex part, which is also one of the characteristics of the edge part of the wafer.

To an area where an integrated circuit is formed, a mirror finish is applied, and further, a resist film and a protective film are applied under a precise control during various process steps. On the other hand, processing on the edge part of the wafer is performed in a relatively rough manner, and further, a coating control regarding the resist film and the like in a lithography process is not performed on the edge part.

Accordingly, there is a possibility that the edge part has a defect which may affect the area on which the integrated circuit is formed. Further, there is also a possibility that such a defective portion is collapsed during processing in various process steps or during a transfer, resulting that particles are generated, and the particles adhere to the area on which the integrated circuit is formed. Further, there is also a case where peeling of various films, bubbles in the films, a film wraparound, and the like in the edge part adversely affect the later process steps.

As inspection techniques of inspecting the edge part to detect such defects, a substance detecting technique using a scattered light being an irradiated laser light or the like, a technique of detecting a concavity and convexity such as microscopic defects based on a brightness/darkness appeared on the edge part when the edge part is illuminated by a diffused light (refer to Patent Document 1: Japanese Unexamined Patent Application Publication No. 2003-139523) and the like, for instance, have been proposed.

Incidentally, in recent years, a case has been reported in which microscopic particles and the like adhered to the edge part are moved to the area on which the integrated circuit is formed during a transfer and the like, and this affects an application of the resist film, exposure processing and the like. Further, it has also been understood that a microscopic defect such as a dent may affect even the area on which the integrated circuit is formed during various process steps, which may lead to damage.

Accordingly, there has been proposed a technique of preventing the generation and adhesion of particles by polishing the edge part to remove the microscopic defect such as the dent before the defect leads to a serious damage.

When the edge part is polished, the microscopic defect is removed by the polishing, but, there is a possibility that a polishing scratch is left on the edge part due to the polishing. Therefore, a technology for inspecting a surface of the polished edge part to judge whether the polishing scratch is left or not, has been required.

The polishing scratch formed due to the polishing has a depth of 1 micron or less and is quite microscopic. As a method of observing such a microscopic polishing scratch, a high power microscope such as a scanning electron microscope (SEM) has been conventionally used. However, to apply the above method, a destructive handling such as cutting a part of the wafer as a sample is required, and thus the method could not be adopted for inspecting the wafer in a manufacturing process for integrated circuit.

### SUMMARY

A proposition of the present embodiment is to provide a surface inspection apparatus and a surface inspection method for detecting a microscopic defect including a polishing scratch on an edge part of a wafer.

The aforementioned proposition is achieved by a surface inspection apparatus that includes an illuminating part that illuminates an edge part of a substrate from a direction deviated from a direction of normal line of the edge part by an angle being predetermined, the edge part being inclined and the substrate being an inspection target, an imaging optics that forms an image from a diffracted light from an captured area of the edge part as a dark field image, an imaging part that captures the dark field image obtained by the imaging optics, and a detecting part that detects a defect based on whether or not a striated image appears on the dark field image corresponding to the edge part obtained by the imaging part.

Further, the above-described proposition can also be achieved by a surface inspection apparatus that corresponds to the aforementioned surface inspection apparatus in which the illuminating part is provided with a white light source which emits a white light.

Similarly, the above-described proposition can also be achieved by a surface inspection apparatus that corresponds to the aforementioned surface inspection apparatus provided with a rotating mechanism that rotates the substrate relatively to the illuminating part and the imaging optics around a vicinity of a center of the substrate being the inspection target as a rotation axis, and a cooperation controlling part that obtains an image corresponding to a circumference of the edge part of the substrate by controlling the rotating mechanism and the imaging part to work in cooperation.

Further, the above-described proposition is also achieved by a surface inspection apparatus that corresponds to the aforementioned surface inspection apparatus whose illuminating part is provided with an adjusting part which adjusts the angle for illuminating the edge part.

Further, the above-described proposition is also achieved by a surface inspection apparatus that corresponds to the aforementioned surface inspection apparatus in which the angle being predetermined at the illuminating part falls within a range of 40 to 70 degrees.

Further, the above-described proposition can be achieved by a surface inspection method including steps of illuminating an edge part of a substrate from a direction deviated from a direction of normal line of the edge part by an angle being predetermined, the edge part being inclined and the substrate being an inspection target, forming an image from a diffracted light from an captured area of the edge part as a dark field image and capturing the dark field image obtained by an imaging optics, and detecting a defect based on whether or not a striated image appears on the dark field image corresponding to the edge part.

### BRIEF DESCRIPTION OF THE DRAWINGS

FIG. 1 is a view representing an embodiment of a surface inspection apparatus.

FIG. 2 is a view representing an example of an observational image (when there are scratches).

FIG. 3 is a view representing an example of an observational image (when there are no scratches).

FIG. 4 is a view for explaining an experiment regarding an arrangement of an illuminating part.

FIGS. 5A and 5B are views representing examples of arrangement of an objective lens and the illuminating part.

FIG. 6 is a view representing another embodiment of the surface inspection apparatus.

FIG. 7 is a view for explaining a captured area.

FIG. 8 is a view representing still another embodiment of the surface inspection apparatus.

FIG. 9 is a view representing yet another embodiment of the surface inspection apparatus.

### DETAILED DESCRIPTION OF EMBODIMENTS

Hereinafter, embodiments of the present invention will be described in detail based on the drawings.

### Embodiment 1

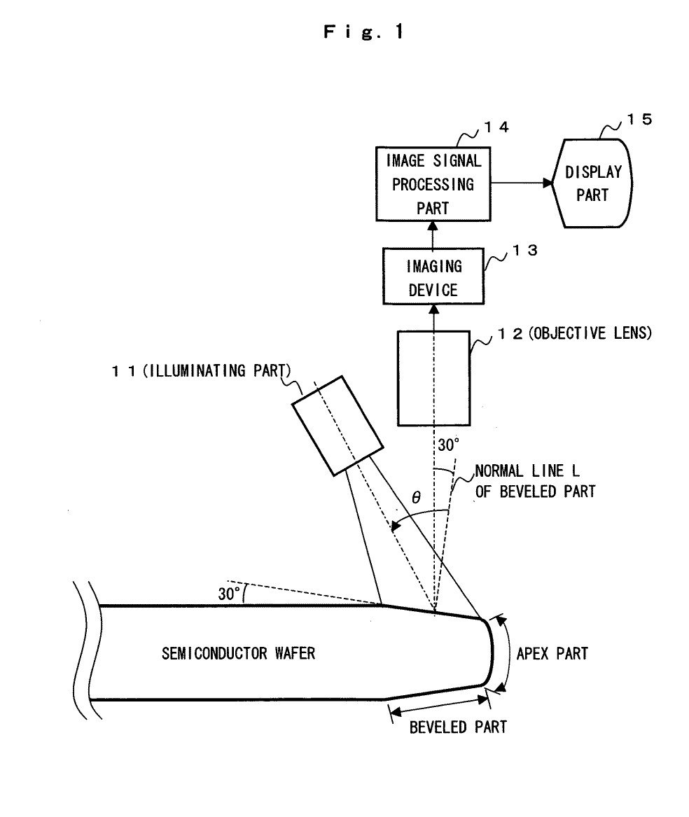

FIG. 1 represents an embodiment of a surface inspection apparatus according to the present invention.

In the surface inspection apparatus represented in FIG. 1, an illuminating part 11 illuminates a beveled part included in an edge part of a semiconductor wafer as an example of a substrate being an inspection target by condensing luminous flux emitted by a white light source. The illuminating part 11 is arranged so that an optical axis thereof makes a predetermined angle θ with a normal line L (represented by a dotted line in FIG. 1) perpendicular to a surface of the beveled part of the semiconductor wafer being the inspection target.

Further, in FIG. 1, an objective lens 12 is arranged so that an optical axis thereof coincides with a line which is parallel to a normal line perpendicular to a surface of the semiconductor wafer (substrate) being the inspection target and intersects with the aforementioned optical axis of the illuminating part 11, for instance. The objective lens 12 forms an image from a diffracted light from a captured area of the beveled part illuminated by the illuminating part 11 on an imaging device 13. As the objective lens 12, a four-power telecentric objective lens, for example, can be used.

In such an arrangement, a zero order light generated by a regular reflection at the surface of the beveled part does not enter the objective lens 12. Further, the diffracted light generated by the beveled part selectively enters the objective lens 12, and the objective lens 12 forms an optical image formed by the diffracted light on the imaging device 13.

An image signal obtained by the imaging device 13 represented in FIG. 1 is provided for display processing performed by a display part 15 via an image signal processing part 14. Consequently, it is possible to observe a diffraction pattern corresponding to the aforementioned captured area of the beveled part as a display image displayed by the display part 15.

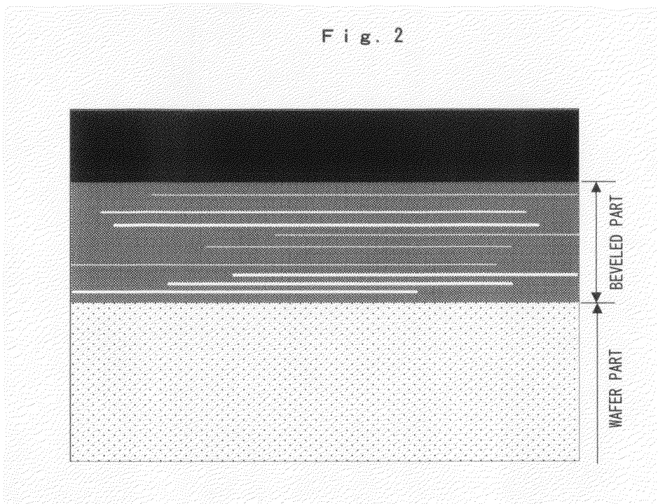

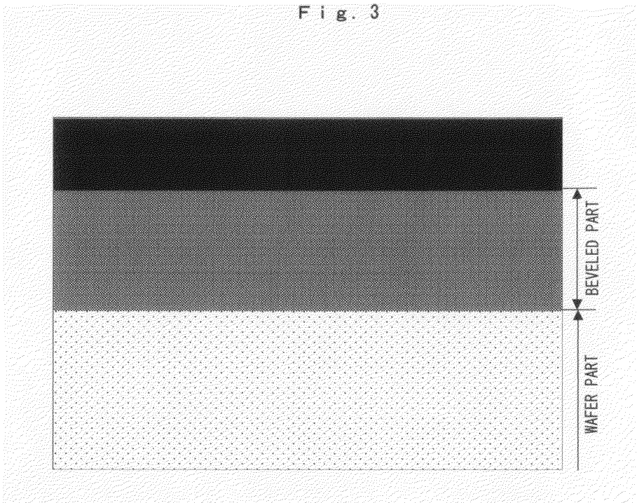

FIG. 2 and FIG. 3 represent schematic views of observational images obtained when the present applicant experimentally observes a beveled part of a semiconductor wafer using the surface inspection apparatus represented in FIG. 1.

When striated defects such as polishing scratches exist on the beveled part, an illuminating light is diffracted by each of the scratches, and a primary diffracted light or a high order diffracted light such as the one of secondary or higher order enters the objective lens 12. In this case, thin striated diffraction patterns are formed on the imaging device 13 in a dark field, as represented in FIG. 2.

On the other hand, when no defects exist on the beveled part, the illuminating light is completely reflected by the surface of the beveled part, so that no diffraction patterns are formed on the imaging device 13. Accordingly, as represented in FIG. 3, the beveled part is observed as a uniformly dark area.

Therefore, according to the surface inspection apparatus represented in FIG. 1, it is possible to intuitively determine, based on whether or not bright lines as represented in FIG. 2 appear on the display image displayed by the display part 15, whether or not the microscopic defects such as the polishing scratches exist on the beveled part. For instance, when the observational image as represented in FIG. 2 is obtained, it can be confirmed that various lengths of polishing scratches are left on the beveled part of the semiconductor wafer being the inspection target.

Further, the applicant conducted an experiment in which a direction of the optical axis of the illuminating part 11 is changed in a state where the objective lens 12 represented in FIG. 1 is fixed by setting the optical axis thereof parallel to the direction of normal line perpendicular to the surface of the semiconductor wafer, thereby searching for a condition suited for observing the diffraction patterns.

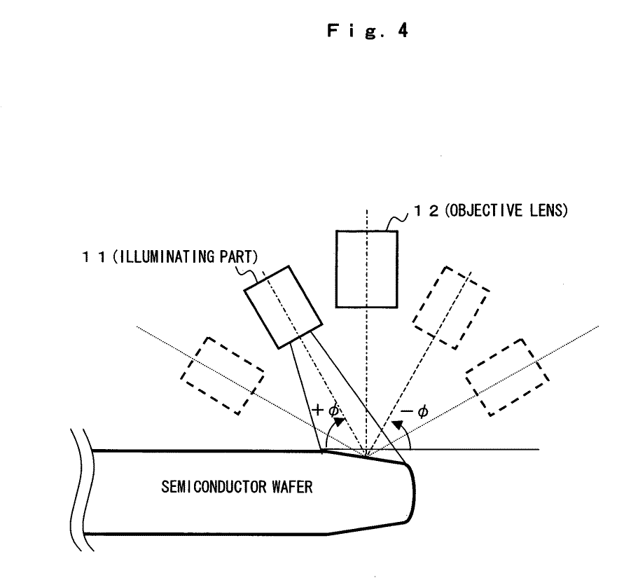

FIG. 4 represents a view for explaining the experiment regarding the arrangement of the illuminating part. Note that in FIG. 4, an angle φ of the optical axis of the illuminating part 11 clockwise from a horizontal plane including the surface of the semiconductor wafer is expressed as a positive angle, and that counterclockwise from the horizontal plane is expressed as a negative angle.

The applicant conducted the observation of diffraction patterns in the above-described manner in cases where the angle φ of the optical axis of the illuminating part 11 is ±30 degrees, ±50 degrees, ±70 degrees, and ±80 degrees.

From the result of this experiment, it is confirmed that the diffraction patterns are not observed when the illuminating part 11 is arranged on a center side of the semiconductor wafer from which it illuminates the beveled part at a sharp angle φ of 50 degrees or less. Further, when the illuminating part 11 is arranged on an outside of an outer edge of the semiconductor wafer (when the angle φ is a negative angle), it is confirmed that in all cases, it is difficult to determine the presence/absence of the diffraction patterns since a regular reflection light enters the objective lens 12.

Further, it is confirmed that the diffraction patterns of polishing scratches on the beveled part can be observed when the illuminating part 11 is arranged on the center side of the semiconductor wafer from which it illuminates the beveled part at an angle φ ranged from 50 to 80 degrees. In particular, when the angle φ is in a range of 70 to 80 degrees, the diffraction patterns could be observed relatively brightly.

From the above, it can be said that the arrangement of the illuminating part 11 in which an angle between the optical axis of the illuminating part 11 and the surface of the semiconductor wafer falls within the aforementioned range, is suitable for observing the diffraction patterns. For instance, the illuminating part 11 may be arranged on the center side of the semiconductor wafer than the objective lens 12, in which an angle between the optical axis of the illuminating part 11 and the optical axis of the objective lens 12 becomes 10 to 20 degrees.

Here, since the beveled part is inclined at −30 degrees to the surface of the wafer, the optical axis of the objective lens 12 for observation is inclined at 30 degrees to the normal line of the beveled part. Specifically, it can be said that the illuminating light from the illuminating part 11 is preferably illuminated in the same inclination direction of the optical axis of the objective lens 12 at an inclination of 40 to 70 degrees, particularly preferably 40 to 50 degrees, to the normal line of the beveled part.

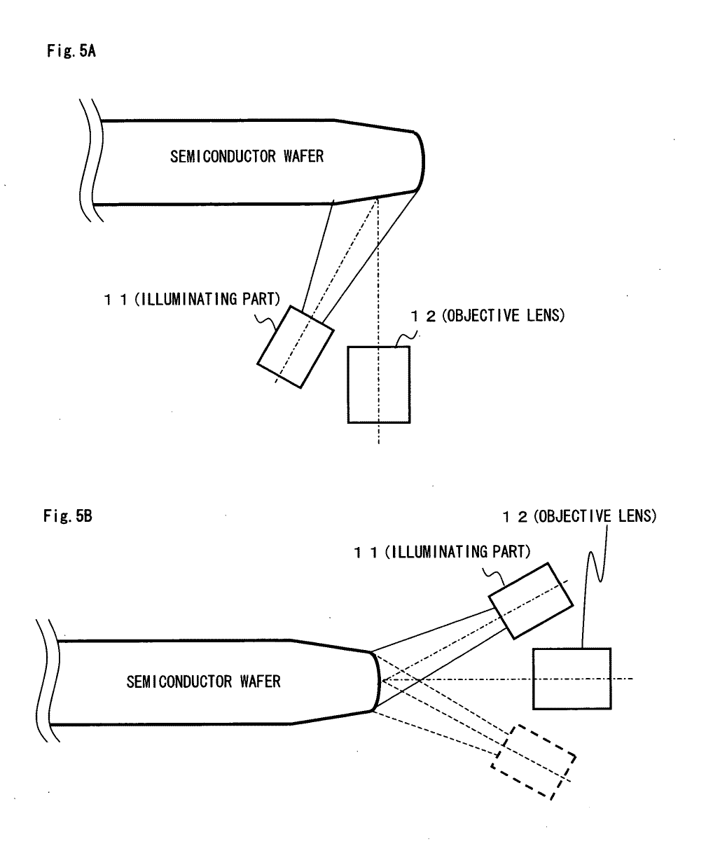

Note that with the arrangement as represented in FIG. 5A, it is possible to observe diffraction patterns of a lower-side beveled part opposite to the beveled part illuminated by the illuminating part 11 represented in FIG. 1. In an example represented in FIG. 5A, the objective lens 12 is arranged in a state where the optical axis thereof coincides with a normal line perpendicular to a rear surface of the semiconductor wafer. Further, the illuminating part 11 is arranged further on the center side of the semiconductor wafer than the objective lens 12 so that an angle between the optical axis of the illuminating part 11 and the rear surface of the semiconductor wafer falls within the aforementioned range. For example, the illuminating part 11 is aligned by making the optical axis thereof inclined with respect to the optical axis of the objective lens 12 by 10 to 20 degrees.

Further, with the arrangement as represented in FIG. 5B, it is possible to observe diffraction patterns of the apex part. In an example represented in FIG. 5B, the objective lens 12 is arranged in a state where the optical axis thereof coincides with a normal line perpendicular to a vertex of the apex part. Further, the illuminating part 11 is arranged to face an observation target area of the apex part so that an angle between the optical axis of the illuminating part 11 and a tangent plane at the vertex of the apex part falls within the aforementioned range. For example, as represented by a solid line position or a dotted line position in FIG. 5B, the illuminating part 11 is aligned by making the optical axis thereof inclined with respect to the optical axis of the objective lens 12 by 40 to 50 degrees.

Further, when a white light source is used as a light source of the illuminating part 11 represented in FIG. 1, the beveled part (or the apex part) being the observation target is illuminated by a light flux including lights of various wavelengths distributed in a wide wavelength range. Accordingly, there is a high possibility that the light of wavelength satisfying the condition under which the diffracted light from scratches that exist on the beveled part (or the apex part) being the captured area enters the objective lens 12 is included in the illuminating light. Consequently, the diffracted lights from the defects of various widths and depths enter the objective lens, and appear as various colors of bright lines. Specifically, with the configuration using the white light source, it is possible to collectively observe the diffraction patterns corresponding to the defects of various widths and depths.

Note that as the light source provided in the illuminating part 11, a monochromatic light source such as a sodium vapor lamp can also be used.

### Embodiment 2

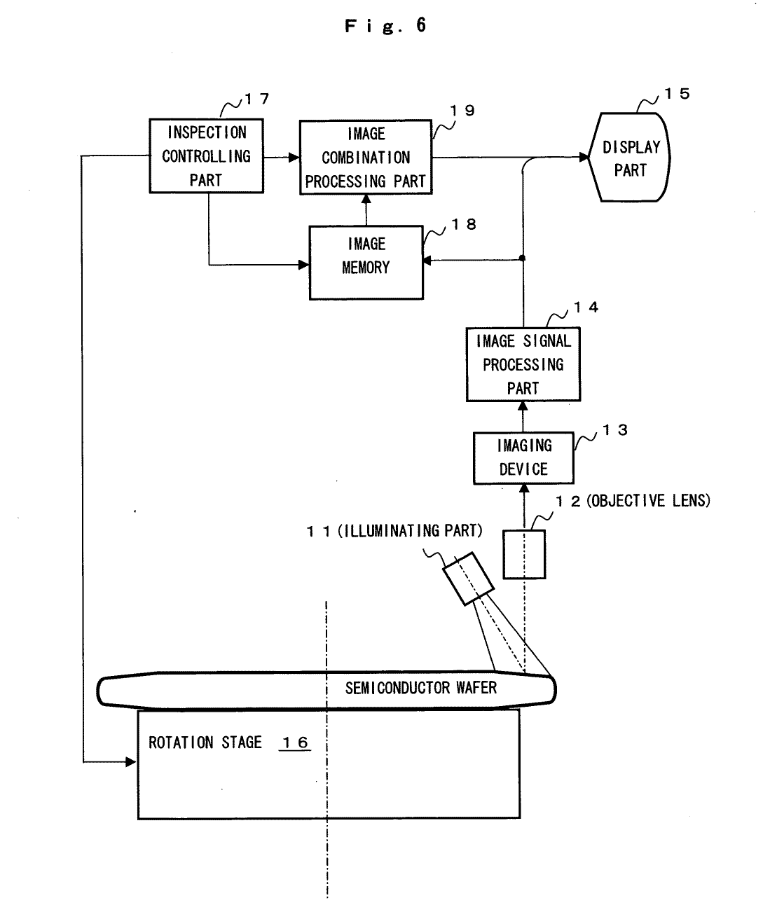

FIG. 6 represents another embodiment of the surface inspection apparatus according to the present invention.

Note that among the components represented in FIG. 6, those corresponding to the respective parts represented in FIG. 1 are denoted by the reference numerals represented in FIG. 1, and an explanation thereof will be omitted.

A semiconductor wafer represented in FIG. 6 is aligned in a state where a rotation center thereof coincides with a rotation axis of a rotation stage 16. A rotational operation of the rotation stage 16 is controlled by an inspection controlling part 17.

Further, an image memory 18 represented in FIG. 6 holds, in accordance with an instruction from the inspection controlling part 17, image data obtained by the image signal processing part 14.

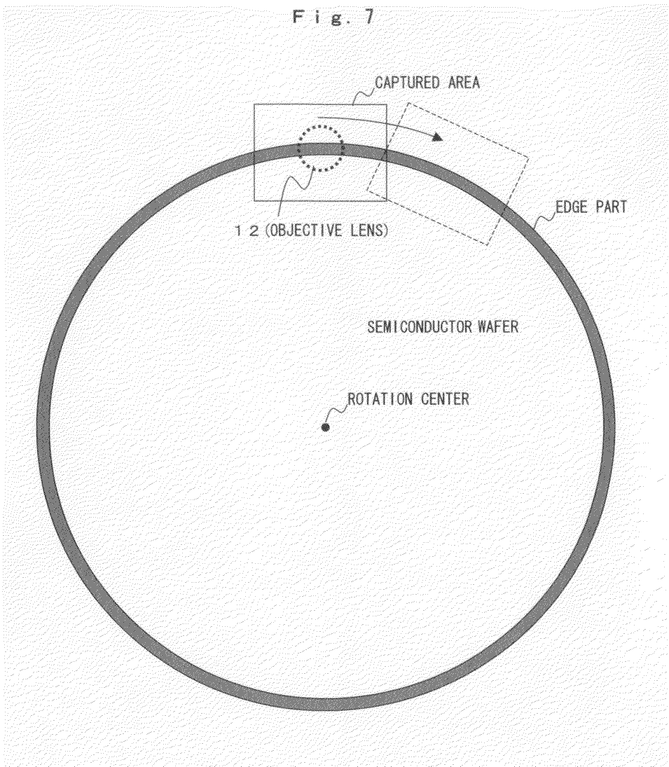

FIG. 7 represents a view for explaining a captured area. In an example represented in FIG. 7, the captured area is shifted by rotating the semiconductor wafer or the illuminating part 11, the objective lens 12 and the imaging device 13 in a relative manner around a center of the semiconductor wafer as a rotation center. In the process of shifting the captured area as described above, the image data obtained at an observation position appropriately determined is held in the image memory 18. Accordingly, it is possible to observe the circumference of the edge part of the semiconductor wafer via the display part 15, and to accumulate the image data corresponding to the circumference of the edge part in the image memory 18.

An image combination processing part 19 represented in FIG. 6 combines, in accordance with an instruction from the inspection controlling part 17, the pieces of image data accumulated in the image memory 18 as described above. Accordingly, the image combination processing part 19 generates image data that represents the whole edge part in a circular-ring shape, and provides the image data for the display processing performed by the display part 15.

As above, it is possible to automatically generate the image data that represents the whole edge part in a circular-ring shape, and to provide, based on the image data, the image of the whole edge part in a collective manner to a user. The user can inspect the polishing scratches over the circumference of the edge part without omission, based on the image of the whole edge part.

Further, it is also possible to realize an automation of the inspection. For example, it is possible to provide the image data obtained at the predetermined observation position to the user so that he/she can visually observe the data through the display processing performed by the display part 15, and to perform the processing to detect the striated diffraction patterns as represented in FIG. 2 on the corresponding image data held in the image memory 18.

Note that instead of rotating the semiconductor wafer around the center thereof using the rotation stage 16 represented in FIG. 6, a structure in which the illuminating part 11, the objective lens 12 and the imaging device 13 are aligned may be rotated around the center of the semiconductor wafer as a rotation center. If such a rotating mechanism is provided, it is possible to achieve the aforementioned relative rotation, similarly as in the apparatus represented in FIG. 6.

### Embodiment 3

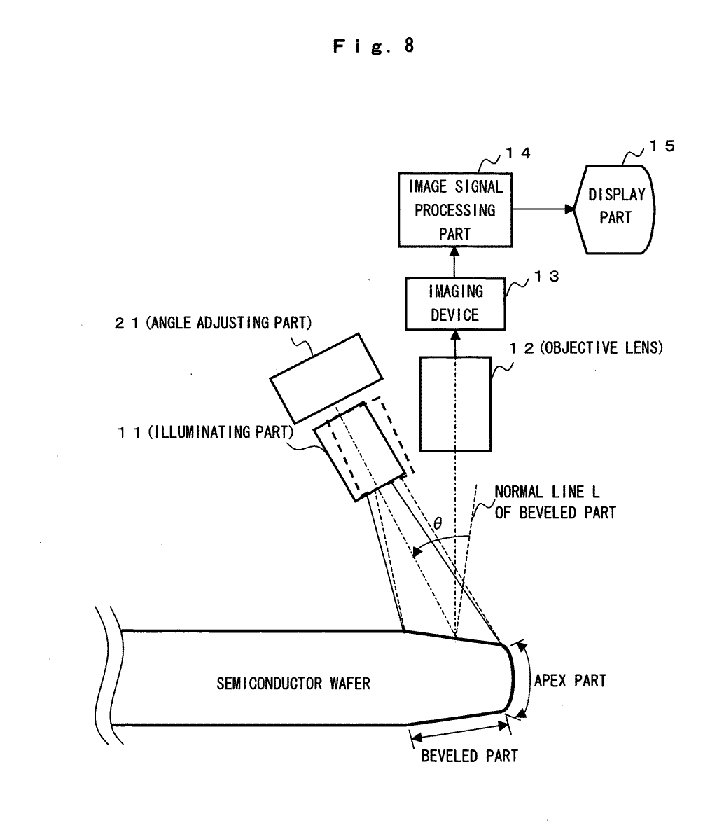

FIG. 8 represents still another embodiment of the surface inspection apparatus according to the present invention.

Note that among the components represented in FIG. 8, those corresponding to the respective parts represented in FIG. 1 are denoted by the reference numerals represented in FIG. 1, and an explanation thereof will be omitted.

The surface inspection apparatus represented in FIG. 8 is provided with an angle adjusting part 21 that adjusts an optical axis direction of the illuminating part 11.

For instance, the angle adjusting part 21 adjusts the direction of the optical axis of the illuminating part 11 within a predetermined range including a range where an angle between the optical axis of the objective lens 12 and the optical axis of the illuminating part 11 becomes 10 to 20 degrees, by rotating the illuminating part 11 around the vicinity of an intersection point between the optical axis of the objective lens and the beveled part as a rotation center. By observing the diffraction patterns obtained from the beveled part through such an adjustment process of the illuminating part 11, it is possible to find the optimum illuminating angle for observing the diffraction patterns obtained from the beveled part of the semiconductor wafer being the inspection target. Further, by adopting the arrangement applying the illuminating angle, it is possible to conduct the surface inspection under an appropriate observation condition.

Further, it is also possible to find the optimum illuminating angle for observing the diffraction patterns obtained from the apex part, in the same manner.

Accordingly, it becomes possible to detect, regardless of the inclination of the beveled part and the apex part of the semiconductor wafer being the inspection target, the microscopic defects such as the polishing scratches on the beveled part and the apex part without omission.

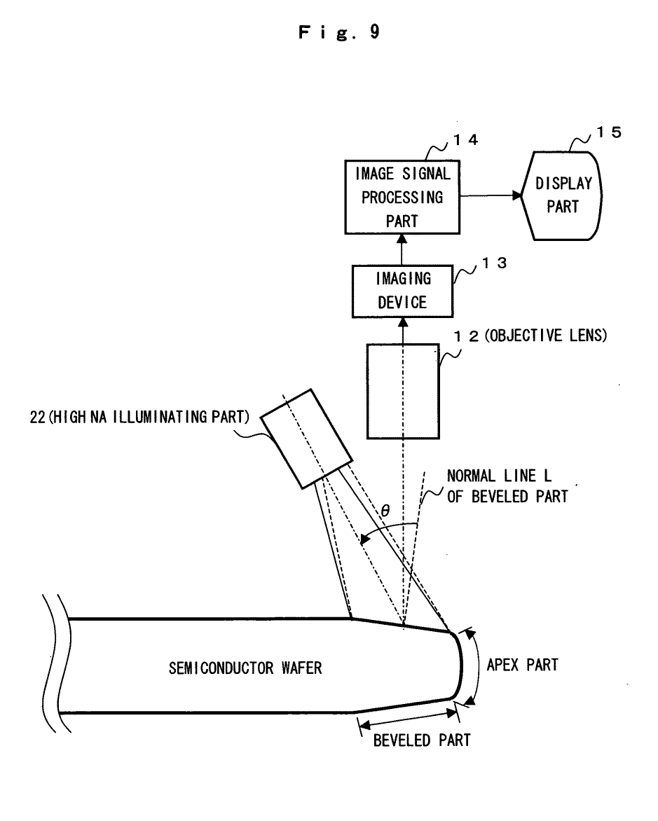

It is also possible to configure a surface inspection apparatus by providing therein, instead of the angle adjusting part 21 represented in FIG. 8, a high numerical aperture (NA) illuminating part 22, as represented in FIG. 9.

The high NA lighting part 22 represented in FIG. 9 can illuminate the beveled part with lights emitted with various angles. Therefore, various orders of diffracted lights generated by the diffraction at the beveled part enter the objective lens 12, and diffraction patterns formed by these diffracted lights can be obtained. Among the diffraction patterns obtained as above, a diffraction pattern obtained when the angle of the optical axis of the illuminating part 11 is adjusted to be an optimum angle by the angle adjusting part 21 represented in FIG. 8, is also included.

Therefore, the surface inspection apparatus represented in FIG. 9 can detect, regardless of the inclination of the beveled part and the apex part of the semiconductor wafer being the inspection target, the microscopic defects such as the polishing scratches on the beveled part and the apex part without omission, similarly as in the surface inspection apparatus provided with the angle adjusting part 21.

Further, it can be predicted that when the processing on the edge part of the wafer is performed with high accuracy, the scratches to be detected become more microscopic. In such a case, by appropriately setting the illuminating angle in accordance with the degree of scratches to be detected, it is possible to maintain the detection accuracy of the surface inspection apparatus.

Note that a two-dimensional amplification type solid-state imaging device such as a CCD or a CMOS image sensor can be used as the imaging device. Further, when the substrate is rotated as described in the embodiment 2, a line image sensor can also be used as the imaging device.

According to the surface inspection apparatus and the surface inspection method structured as above, it is possible to determine whether or not the quite microscopic scratches including the polishing scratches are left on the edge part including the beveled part and the apex part of the outer edge of the semiconductor wafer, based on the presence/absence of the diffraction patterns. The diffraction pattern can be visualized using a relatively low power imaging optics. Therefore, according to the aforementioned surface inspection apparatus, it is possible to detect the microscopic defects on the edge part of the semiconductor wafer without omission, and to provide the detection result for the inspection to inspect whether the polishing state of the edge part of the semiconductor wafer is acceptable or not.

The advantage of the surface inspection apparatus configured as above is that there is no need to perform a destructive handling such as cutting a sample for inspection from the semiconductor wafer.

Therefore, the present invention can be applied to a 100% inspection of the semiconductor wafers in the manufacturing process for integrated circuit in which non-destructive inspection is required, which is quite useful in a semiconductor manufacturing field.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A surface inspection apparatus, comprising:
an illuminating part illuminating an edge part of a substrate from a direction deviated from a direction of normal line of the edge part by an angle being predetermined, the edge part being inclined and the substrate being an inspection target;
an imaging optics forming an image from a diffracted light from a captured area of the edge part as a dark field image;
an imaging part capturing the dark field image obtained by the imaging optics; and
a detecting part detecting a defect based on whether or not a striated image appears on the dark field image corresponding to the edge part obtained by the imaging part.

2. The surface inspection apparatus according to claim 1, wherein
the illuminating part is provided with a white light source which emits a white light.

3. The surface inspection apparatus according to claim 1, further comprising:
a rotating mechanism rotating the substrate relatively to the illuminating part and the imaging optics around a vicinity of a center of the substrate being the inspection target as a rotation axis; and
a cooperation controlling part obtaining an image corresponding to a circumference of the edge part of the substrate by controlling the rotating mechanism and the imaging part to work in cooperation.

4. The surface inspection apparatus according to claim 1, wherein
the illuminating part is provided with an adjusting part which adjusts the angle for illuminating the edge part.

5. The surface inspection apparatus according to claim 1, wherein
the angle being predetermined falls within a range of 40 to 70 degrees.

6. A surface inspection method, comprising:
illuminating an edge part of a substrate from a direction deviated from a direction of normal line of the edge part by an angle being predetermined, the edge part being inclined and the substrate being an inspection target;
forming an image from a diffracted light from a captured area of the edge part as a dark field image and capturing the dark field image obtained by an image optics; and
detecting a defect based on whether or not a striated image appears on the dark field image corresponding to the edge part.

7. The surface inspection apparatus according to claim 2, further comprising:
a rotating mechanism rotating the substrate relatively to the illuminating part and the imaging optics around a vicinity of a center of the substrate being the inspection target as a rotation axis; and
a cooperation controlling part obtaining an image corresponding to a circumference of the edge part of the substrate by controlling the rotating mechanism and the imaging part to work in cooperation.

8. The surface inspection apparatus according to claim 2, wherein the illuminating part is provided with an adjusting part which adjusts the angle for illuminating the edge part.
